(19) United States
(12) Patent Application Publication
(10) Pub. No.: US 2016/0283959 A1
(43) Pub. Date: Sep. 29, 2016

(54) Why-Buy/time variable shopping bonus

(71) Applicant: Earl Monroe Lyles, JR., Harrisburg, PA (US)

(72) Inventor: Earl Monroe Lyles, JR., Harrisburg, PA (US)

(21) Appl. No.: 14/714,067

(22) Filed: May 15, 2015

Related U.S. Application Data
(60) Provisional application No. 61/996,794, filed on May 15, 2014.

(51) Int. Cl. G06Q 30/02

(52) U.S. Cl. CPC G06Q 30/0213; G06Q 30/0233

(57) ABSTRACT

A network marketing system in conjunction with a cash back system based on time variables. Network marketing aspect of system can help sponsors acquire free products. Time variable cash back system can help customers acquire free products depending on time variable. The why-buy/time variable shopping bonus system can be used to lower retail value of products or allow products to be acquired free.

### CROSS REFERENCE TO RELATED APPLICATIONS

This application claims priority to provisional patent application No. 61/996,794, filed on May 15, 2014 in the United States Patent and Trademark Office.

### STATEMENT REGARDING FEDERALLY SPONSORED RESEARCH OR DEVELOPMENT

Not applicable

### REFERENCE TO SEQUENCE LISTING, A TABLE, OR COMPUTER PROGRAM LISTING COMPACT DISC APPENDIX

Not applicable

### BACKGROUND OF THE INVENTION

The why-buy/time variable shopping bonus invention pertains to the field of network marketing and general commerce. Many retailers today offer cash back to customers as an incentive for future spending and to reward customers. Many customers today seek ways to use coupons, save money, and acquire the greatest deal. The time variable shopping bonus gives cash back to customers based upon a time variable decided by the company using the time variable shopping bonus system. Percentages or specific amounts of money are allotted to a specific customer based on a certain amount of profit from purchases within a specific time frame.

The time variable shopping bonus system also allots money to customers evenly by sharing profits within a specific time evenly with all customers who spent money within a specific time. Cash back using the time variable shopping bonus system can range from small amounts to abnormally large amounts of cash back. Customers then have the option to spend the allotted funds within a specific time frame.

The why-buy system is a point accumulation system based on recruitment of individuals whereby money is converted to points, or whatever term decided by inventor, on a residual basis and spent on the product/service of choice. When a product is purchased with points it results in a profit or commission payment for the individual(s) sponsor. When a network marketer sales a product using the time variable shopping bonus system it results in a commission payment to the network marketer and the above sponsoring members. A portion of the commission can be converted to points for the network marketer to use for future purchases. The why-buy/time variable shopping bonus system allows both the network marketer and customer to acquire products with little or no cost. One common complaint in current day network marketing is the higher pricing of products in order to pay commissions. The why-buy/time variable shopping bonus system solves the problem for network marketers and customers.

### BRIEF SUMMARY OF THE INVENTION

The why-buy/time variable shopping bonus invention utilizes the process of network marketing in conjunction with a time variable shopping bonus for the purpose of acquiring products and or services without paying retail or wholesale prices for the product by conventional standards. The time variable shopping bonus is a system that determines the amount of cash back a customer will receive based on a time variable. The why-buy invention also utilizes a process of network marketing to acquire products at any price and still maintain a profit. The why-buy invention is a system designed to allow the public and the network marketer to purchase any product at a price well below normal retail or wholesale value and thereby allowing the consumer to keep more of their money. The why-buy invention is designed to allow the person who participates in the network marketing aspect of the invention to acquire products without paying for them by conventional standards of commerce and thereby empowering the person to offer the product to the public at any price and still maintain a profit.

The time-variable shopping bonus is a cash back method that allows the consumer to purchase any product and or service and receive cash back based on a time variable that is determined by allotted percentages of profit being redistributed to the customer within a specified time frame. The cash back can be spent within a specific time allotted by the retailer or network marketing company for the purpose of increasing profit. Percentages of profit may also decrease when cash back is given using the time-variable system with the intent of allowing a certain loss with the purpose of increasing consumer spending which leads to overall profitability in the long term. A portion of the profit from the sale of the products using the time variable shopping bonus system can be converted to funds referred to as points, or the term determined by company, that the network marketer can then use to acquire more products for personal use and sale to the public at a discounted price.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 exemplarily illustrates a graphical representation showing a profit received by a company for next 55 transactions immediately after Customer A has made a purchase.

FIG. 2 exemplarily illustrates a graphical representation showing a number of transactions taking place over a period of 10 minutes after Customer A has made a purchase.

FIG. 3 exemplarily illustrates a graphical representation showing profit received by Customer A as a result of purchases made by other customers over a period of 10 minutes after Customer A makes a purchase.

### DETAILED DESCRIPTION OF THE INVENTION

The why-buy/time variable shopping bonus invention utilizes the process of network marketing in conjunction with a time variable shopping bonus method for the purpose of acquiring products (any product normally sold retail or wholesale) without paying retail or wholesale price for the product by conventional standards. The first part of the why-buy/time variable shopping bonus invention is the why-buy section which utilizes the process of network marketing. The process of the why-buy invention works by members of a network marketing company paying the company a monthly or annual fee. When the member pays the fee a portion of the fee is converted to points or whatever term decided by the company. These point can then be used to acquire the products offered by the company. Members of the network marketing company can also sponsor new members.

When a new member joins and pays their monthly, annual, or time appointed fee, the sponsoring member also receives currency in the form of points for sponsoring that person. For example, Member A sponsors Member B who pays $55 dollars per month for their membership fee. $20 dollars from member B is converted to 1 point every month. The sponsoring person Member A is rewarded ½ point or $10 every month for Member B when Member B pays the fee and remains a member.

Points can be accumulated and held as residual from each person sponsored by another member. A person can accumulate points from several tiers depending on the company's discretion. For example, Member A recruits Member B who recruits Member C who recruits Member D. Member A can accumulate points from Members A, B, C, and D as long as they pay their time appointed residual fee. Points accumulated by members is equivalent to money which is being paid on a time appointed basis.

When a member uses his points to acquire a product offered by the company sponsor can earn a monetary commission from the product purchased. For example Member B has sponsored ten people. Each month these 10 people pay a 55 dollar membership fee. Member B earns ½ point for each person on a monthly basis. This is equivalent to 10 dollars per person on a monthly basis. Member B has a total of 100 dollars at the end of the month to purchase new products. Member B chooses to purchase a watch. The retail value of the watch is $100. The wholesale value of the watch is 20 dollars. The network marketing company paid 20 dollars for the watch and profited 80 dollars. Member A now can receive a monetary commission from the purchase of member B because member A is the sponsor of Member B. Commissions can be converted to points and then spent within the company which results in a commission for the sponsoring member.

Each time a member purchases a product with their points their sponsor profits from each product. The purpose of the invention is to offer multiple products and/or services which can be lucrative for those members who have recruited multiple members. The points accumulated can be used to purchase many of the products offered including other products that require a monthly fee. Every member can earn a minimum commission from those they sponsored and the commission can be increased depending on how many people they have sponsored. For example, a member can earn 10% commission each time someone they have sponsored uses their points to acquire a product. Commissions can increase with each new member sponsored depending on the company's discretion.

The pay structure for example may consist of three tiers. Member A sponsored 5 people. Those 5 people have each sponsored 5 people. Member A has 10 people in his line of sponsorship on a three tier pay system. Each time one of Member A's sponsored members purchases a product Member A receives a commission determined by the company. Member A can also receive a commission when those on the third level use their points to purchase a product.

Each sponsored member will also sell products to the public using the time variable shopping bonus system. Members will earn a commission each time they sell a product using the time variable shopping bonus system. For example Member B has sold 200 products using the time variable system. Member A will receive a commission on each product sold since Member A sponsored Member B. A proportion of points accumulated can be used to buy products to offer to the public at a reduced price. For example, the company decided 15% percent of all points will be used for this purpose. 15% of Member A's points equals 200 dollars. Member A chooses to offer a television on a web site portal to the general public. The television cost 200 dollars but because these points were not accumulated from personal funds Member A can afford to offer it to the public at a reduced price and still make a profit. So now the television can be offered to the public at 30 dollars and members still make a profit.

The second part of the invention consists of the time variable shopping bonus. This concept is designed to increase consumer spending and make it easier for network marketers and retailers to sell products. The time variable shopping bonus works by offering a cash back bonus to a consumer who purchased a product. Cash back is determined by a percentage or specific amount of currency from other customers who purchased products before or after another customer. For example, Customer A just bought a telephone. Now customer A must wait for the next 50 purchases or whatever number decided by the company. As an example, customer A may receive 3% of the profit from the next 50 purchases or Customer A may receive a specific dollar amount of cash back from the next 50 purchases. Customer A will then be given a designated amount of time to spend the cash back received.

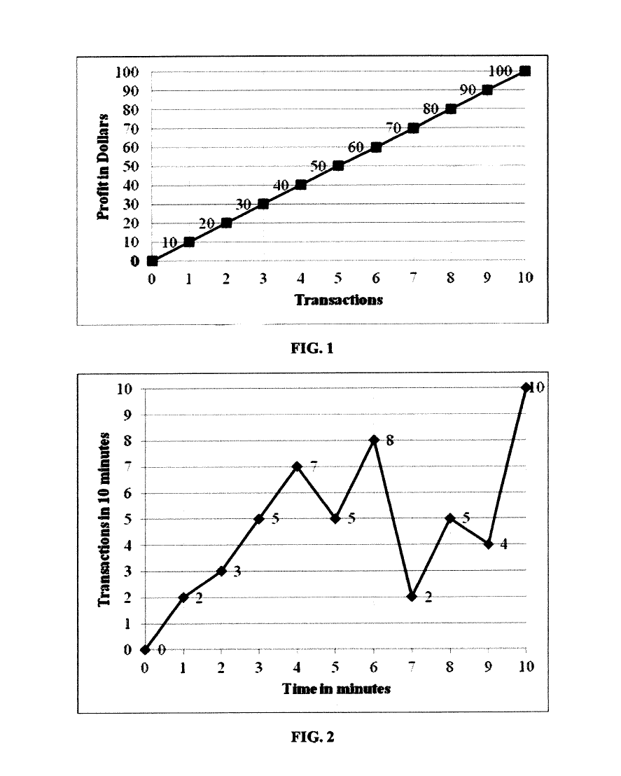

In another example illustrated in FIG. 1, customer A has just bought a computer. After customer A buys the computer he waits while his bonus is calculated or his bonus may have been calculated from previous purchases. His bonus is based on post purchases. The system is set to reward customer A after the next 55 transactions are performed on the system. The total profit received by the company from the next 55 transactions is 550 dollars. The cash back amount receivable by Customer A is set as 30%. Customer A will therefore receive a total of 165 dollars cash back. After customer A gets his cash back bonus he can spend that money at another retailer where his purchase can then add cash back to another customer at a different retailer.

The design of the software for the why-buy/time variable shopping bonus system can be set for milli-seconds, seconds, minutes, hours, or days and the time frame for the time variable shopping bonus can be changed at any time to sustain comfortable profit margin for the company. The time variable shopping bonus system is designed capture and track the amount of transactions within a time frame and the percentage of profit within a certain time frame.

The time variable shopping bonus is designed to average the amount of purchases there were within a certain time frame. Then set the bonus amount to that time frame. For example, if a company averages 1000 sales per minute then time variable shopping bonus software will average how often a purchase was made within that minute. If consumer A made the purchase at 0.06 seconds within the minute the software can be set to give a cash back bonus based on all transactions that took place within the next minute after Consumer A's purchase. Consumer A may receive a portion of the last 1000 purchases as part of the cash back system.

The time variable shopping bonus system software can also be used to disperse cash back on an even basis. For example, if a company has averaged 1000 sales per minute and the profit is 75 dollars per sale then that would equate to 75,000 dollars profit. The company decides the bonus rate for that day is 35%. That would leave 26,250 dollars to be distributed evenly amongst 1000 customers. So each customer will get 26.50 cash back.

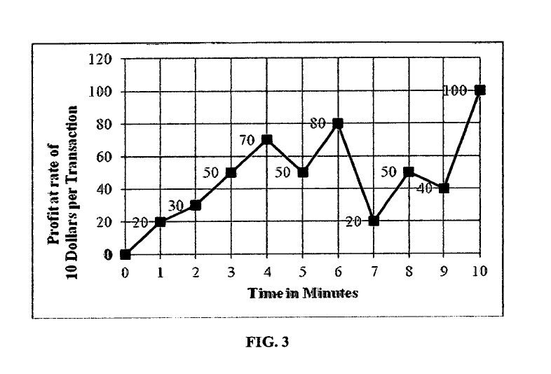

FIG. 2 exemplarily illustrates a graphical representation showing a number of transactions taking place over a period of 10 minutes after Customer A has made a purchase. The number of transactions is recorded each minute. The total number of transactions recorded over the 10 minute period is 51 transactions. The time variable shopping bonus system comprises software to track transactions within certain time frames at one to multiple retailers on the internet or offline. If the software is set to give cash back based on a 10 minute time frame then Customer A will receive a percentage or a specific amount of money per each transaction ten minutes after his purchase.

FIG. 3 exemplarily illustrates a graphical representation showing profit received by Customer A as a result of purchases made by other customers over a period of 10 minutes after Customer A makes a purchase. For simplicity, the number of transactions made by the other customers over the period of 10 minutes after Customer A makes his purchase is taken as 51, same as in FIG. 2. Customer A will be rewarded 10 dollars per transaction that has taken place over the course of ten minutes. Customer A will therefore receive a total of 510 dollars cash back. Customer A will then be given a certain amount of time to spend the cash back bonus. It can be mandated the bonus is spent at a different retailer to avoid one specific retailer from losing profit. Customer A may also be mandated to make one more purchase before the bonus is given. Customer B is the next customer after Customer A that makes a purchase on the system. Customer B will then wait 10 minutes or whatever time decided by the company to receive his bonus calculated by the software.

The why-buy/time variable shopping bonus system will have to by utilized by software that can be either integrated into cash register software, mobile device, purchase card software (i.e. credit card), and computer device for real time tracking of transactions in order to calculate the principles the why-buy/time variable shopping bonus system are based on.

1-6. (canceled)

7. A system, comprising:
a computer device for real time tracking of transactions performed within a network marketing company;
a software application executable by said computer device for:
enrolling a plurality of members into a network marketing company, wherein each member pays a membership fee to said network marketing company, and wherein said membership fee comprises one of a monthly membership fee and an annual membership fee;
enrolling one or more new members into said system, wherein said one or more new members are sponsored by one or more of said members and creating tiers of members for each of said members, wherein a first tier of members comprise non-sponsored members, wherein a second tier of members comprise said new members sponsored by said non-sponsored members, wherein a third tier and subsequent tier of members comprise members sponsored by one or more of said second tier and preceding tier of members;
rewarding each of said members of said network marketing company with points when each of said members pay said membership fee to said network marketing company;
rewarding each of said members of said network marketing company with points when each of said members sell products of said network marketing company;
rewarding each of said members of said network marketing company with points when corresponding sponsored new members in each of said tiers pay said membership fee; and
rewarding each of said members of said network marketing company with points when said corresponding new members in each of said tiers sell said products of said network marketing company.

8. The system of claim 7, wherein said system individually accumulates said reward points of each of said members and allows said members to use said individually accumulated reward points to purchase said products provided for sale by said network marketing company including products that require a monthly fee.

9. The system of claim 8, wherein said system accepts said purchase of said products if said individually accumulated reward points are used within a predefined time period.

10. The system of claim 7, wherein said system individually accumulates said reward points of each of said members and allows said members to use a portion of said individually accumulated reward points to purchase said product provided for sale by said network marketing company, and wherein said system allows said members to sell said purchased product through said system at a reduced price.

11. A system, comprising:
a computer device for real time tracking of transactions performed by one or more customers on said system;
said computer device providing one or more of a product and a service for sale through said system to said customer; and
a software application executable by said computer device for one of:
rewarding said customer when said customer purchases one or more of said product and said service, wherein said reward is a cash back amount calculated as a percentage or a specific amount of money for each transaction multiplied by number of transactions performed by other customers within a specified time frame;
rewarding said customer when said customer purchases one or more of said product and said service, wherein said reward is a cash back amount calculated as an average number of transactions performed on said system by all customers within a specified time frame multiplied by an average percentage of profit or a specific amount of currency per transaction;
rewarding all customers evenly with a cash back amount calculated as total amount of distributable profit for all transactions performed by said customers within a specified time frame divided by number of said customers performing said transactions within said specified time frame; and
rewarding said customer when said customer performs a first transaction comprising a purchase of one or more of said product and said service, where said reward is a cash back amount calculated as a set number of transactions occurring after said first transaction multiplied by a set percentage of profit for said set number of transactions occurring after said first transaction.

12. The system of claim 11, wherein said system individually accumulates said cash back amount of each customer and allows said customers to use said individually accumulated cash back points to purchase one or more of said products and said services provided for sale by said system.

13. The system of claim 12, wherein said system accepts said purchase of one or more of said products and said services if said individually accumulated cash back amounts are used within a predefined time period.

14. The system of claim 11, wherein said system individually accumulates said cash back amount of each customer and allows said customers to use a portion of said accumulated cash back amount to purchase a product provided for sale by said system, and wherein said system allows said customer to sell said purchased product through said system at a reduced price.

15. The system of claim 11, wherein said software application when executed by said computer system rewards said customer when said customer performs a first transaction comprising a purchase of one or more of said product and said service, where said customer is rewarded with a cash back amount calculated as a set number of transactions occurring before said first transaction multiplied by a set percentage of profit for said set number of transactions occurring before said first transaction.

16. A method, comprising:
providing a system comprising a computer device and a software application for real time tracking of transactions performed within a network marketing company;
enrolling a plurality of members into said network marketing company, by said system, wherein each member pays a membership fee to said network marketing company, and wherein said membership fee comprises one of a monthly membership fee and an annual membership fee;
enrolling one or more new members into said system, wherein said one or more new members are sponsored by one or more of said members and creating tiers of members for each of said members, wherein a first tier of members comprise non-sponsored members, wherein a second tier of members comprise said new members sponsored by said non-sponsored members, wherein a third tier and subsequent tier of members comprise members sponsored by one or more of said second tier and preceding tier of members;
rewarding each of said members of said network marketing company with points when each of said members pay said membership fee to said network marketing company;
rewarding each of said members of said network marketing company with points when each of said members sell products of said network marketing company;
rewarding each of said members of said network marketing company with points when corresponding sponsored new members in each of said tiers pay said membership fee; and
rewarding each of said members of said network marketing company with points when said corresponding new members in each of said tiers sell said products of said network marketing company.

17. The method of claim 16, wherein said reward points of each of said members are individually accumulated by said system, wherein said system allows said members to use said individually accumulated reward points to purchase said products provided for sale by said network marketing company including products that require a monthly fee.

18. The method of claim 17, wherein said purchase of said products are accepted by said system if said individually accumulated reward points are used within a predefined time period.

19. The method of claim 16, wherein said reward points of each of said members are individually accumulated by said system, wherein said system allows said members to use a portion of said individually accumulated reward points to purchase said products provided for sale by said network marketing company, and wherein said system allows said members to sell said purchased product through said system at a reduced price.

20. The method of claim 16, wherein said reward points of each of said members are individually accumulated by said system, and wherein said system allows said members to convert said individually accumulated reward points into money at a designated time.

21. A method, comprising:
providing a system comprising a computer device and a software application for real time tracking of transactions performed by one or more customers on said system, wherein said system provides one or more of a product and a service for sale through said system to said customer, and wherein said software application is executable by said computer device for one of:
rewarding said customer when said customer purchases one or more of said product and said service, wherein said reward is a cash back amount calculated as a percentage or a specific amount of money for each transaction multiplied by number of transactions performed by other customers within a specified time frame;
rewarding said customer when said customer purchases one or more of said product and said service, wherein said reward is a cash back amount calculated as an average number of transactions performed on said system by all customers within a specified time frame multiplied by an average percentage of profit or a specific amount of currency per transaction;
rewarding all customers evenly with a cash back amount calculated as total amount of distributable profit for all transactions performed by said customers within a specified time frame divided by number of said customers performing said transactions within said specified time frame; and
rewarding said customer when said customer performs a first transaction comprising a purchase of one or more of said product and said service, where said reward is a cash back amount calculated as a set number of transactions occurring after said first transaction multiplied by a set percentage of profit for said set number of transactions occurring after said first transaction.

22. The method of claim 21, wherein said system individually accumulates said cash back amount of each customer and allows said customers to use said individually accumulated cash back points to purchase one or more of said products and said services provided for sale by said system.

23. The method of claim 22, wherein said system accepts said purchase of one or more of said products and said services if said individually accumulated cash back amounts are used within a predefined time period.

24. The method of claim 21, wherein said system individually accumulates said cash back amount of each customer and allows said customers to use a portion of said accumulated cash back amount to purchase a product provided for sale by said system, and wherein said system allows said customer to sell said purchased product through said system at a reduced price.

25. The method of claim 21, wherein said software application when executed by said computer system rewards said customer when said customer performs a first transaction comprising a purchase of one or more of said product and said service, where said customer is rewarded with a cash back amount calculated as a set number of transactions occurring before said first transaction multiplied by a set percentage of profit for said set number of transactions occurring before said first transaction.

26. A non-transitory computer-readable medium comprising machine executable instructions for executing a software application for real time tracking of transactions performed within a network marketing company that, when executed by a computer device, causes said computer device to perform a method comprising:
enrolling a plurality of members into said network marketing company, by said system, wherein each member pays a membership fee to said network marketing company, and wherein said membership fee comprises one of a monthly membership fee and an annual membership fee;
enrolling one or more new members into said system, wherein said one or more new members are sponsored by one or more of said members and creating tiers of members for each of said members, wherein a first tier of members comprise non-sponsored members, wherein a second tier of members comprise said new members sponsored by said non-sponsored members, wherein a third tier and subsequent tier of members comprise members sponsored by one or more of said second tier and preceding tier of members;
rewarding each of said members of said network marketing company with points when each of said members pay said membership fee to said network marketing company;
rewarding each of said members of said network marketing company with points when each of said members sell products of said network marketing company;
rewarding each of said members of said network marketing company with points when corresponding sponsored new members in each of said tiers pay said membership fee; and
rewarding each of said members of said network marketing company with points when said corresponding new members in each of said tiers sell said products of said network marketing company.

27. A non-transitory computer-readable medium comprising machine executable instructions for executing a software application for real time tracking of transactions performed by one or more customers on a system, wherein said system provides one or more of a product and a service for sale through said system to said customer, and wherein said software application when executed by a computer device of said system, causes said computer device to perform a method comprising one of:
rewarding said customer when said customer purchases one or more of said product and said service, wherein said reward is a cash back amount calculated as a percentage or a specific amount of money for each transaction multiplied by number of transactions performed by other customers within a specified time frame;
rewarding said customer when said customer purchases one or more of said product and said service, wherein said reward is a cash back amount calculated as an average number of transactions performed on said system by all customers within a specified time frame multiplied by an average percentage of profit or a specific amount of currency per transaction;
rewarding all customers evenly with a cash back amount calculated as total amount of distributable profit for all transactions performed by said customers within a specified time frame divided by number of said customers performing said transactions within said specified time frame; and
rewarding said customer when said customer performs a first transaction comprising a purchase of one or more of said product and said service, where said reward is a cash back amount calculated as a set number of transactions occurring after said first transaction multiplied by a set percentage of profit for said set number of transactions occurring after said first transaction.
